(19) United States
(12) Patent Application Publication
(10) Pub. No.: US 2026/0212390 A1
(43) Pub. Date: Jul. 23, 2026

(54) System and Method of Vehicle Valuation

(71) Applicant: Kollin Wallace Helm, Bonifay, FL (US)

(72) Inventor: Kollin Wallace Helm, Bonifay, FL (US)

(21) Appl. No.: 19/452,514

(22) Filed: Jan. 19, 2026

Related U.S. Application Data
(60) Provisional application No. 63/747,660, filed on Jan. 21, 2025.

(51) Int. Cl. G06Q 30/02; G06Q 30/0201; G06V 30/14

(52) U.S. Cl. CPC G06Q 30/0278; G06Q 30/0206; G06V 30/14

(57) ABSTRACT

A vehicle information aggregation and valuation system that improves and accelerates vehicle buying and selling by enabling real-time retrieval and presentation of verified vehicle information is disclosed. A mobile application executed on an electronic (i.e., mobile) user device provides user registration and authentication interfaces and captures a vehicle identifier, including a VIN or barcode, using a camera-based reader. The mobile application transmits the vehicle identifier to a backend server platform including an API gateway, authentication module, profile module, orchestration module, and valuation module. The backend platform retrieves vehicle facts from multiple heterogeneous external data sources, computes vehicle valuation information including an estimated vehicle value, and retrieves a third-party vehicle history report. The system further compares vehicle attributes across independent sources to detect and present conflicting vehicle facts and calculates a deal score based on a relationship between listing price and estimated value.

### CROSS-REFERENCE TO RELATED APPLICATION

The present application claims priority to, and the benefit of, U.S. Provisional Application No. 63/747,660 which was filed on January 21, 2025 and is incorporated herein by reference in its entirety.

### FIELD OF THE INVENTION

The present invention generally relates to vehicle information systems. More specifically, the present invention relates to a mobile-based vehicle information aggregation and valuation system configured to improve and accelerate vehicle buying and selling by providing rapid access to verified vehicle data. The invention comprises a multi-component system including an electronic (i.e., mobile) user device executing a mobile application and a backend server platform in network communication with the mobile application. The mobile application is configured to provide one or more graphical user interfaces for user registration and authentication and to capture a vehicle identifier, including a vehicle identification number (VIN) or barcode. The backend server platform includes an orchestration module configured to retrieve vehicle facts from multiple heterogeneous external data sources and to normalize the retrieved information into a canonical vehicle record, as well as a valuation module configured to generate estimated vehicle values and pricing metrics. In certain embodiments, the system further retrieves a third-party vehicle history report responsive to the vehicle identifier and compares vehicle attributes across independent sources to identify and present conflicting vehicle facts. The aggregated vehicle information, valuation data, and vehicle history access are presented within a unified application workflow, thereby reducing user effort, improving accuracy, and enhancing the vehicle buying and selling experience. Accordingly, the present disclosure makes specific reference thereto. Nonetheless, it is to be appreciated that aspects of the present invention are also equally applicable to other like applications, devices, and methods of manufacture.

### BACKGROUND

By way of background, purchasing a vehicle is often a frustrating and difficult experience for many consumers. The process commonly requires a buyer to research multiple types of vehicles and configurations, identify dealerships or private sellers that have vehicles matching the buyer’s desired criteria, and compare pricing options across different sellers and platforms. In many instances, a consumer must consult multiple sources to obtain information relating to vehicle pricing, vehicle specifications, vehicle history, mileage, and other factors that impact the value and suitability of a vehicle.

Further, vehicle information presented through third-party sources is often incomplete, inconsistent, or erroneous, which can create confusion and uncertainty during the purchasing process. In addition to informational complexity, consumers may experience stress and delay due to the time required to perform repeated searches, manually review listings, and validate whether the disclosed information about a vehicle is accurate. Accordingly, individuals desire an improved system that provides a faster, more reliable, and less stressful approach for vehicle buying and selling.

Therefore, there exists a long-felt need in the art for an improved vehicle information aggregation and valuation system that overcomes the limitations of conventional vehicle shopping tools and fragmented third-party information sources. There is a long-felt need for a vehicle buying and selling solution that reduces the time and effort required to research vehicles, locate appropriate inventory at dealerships or private sellers, and compare pricing options across multiple platforms. Additionally, there exists a need for a system that resolves inaccuracies and inconsistencies in third-party vehicle facts. Moreover, there is a need for a unified workflow that enables a user to rapidly obtain reliable vehicle attributes, vehicle valuation information, and vehicle history information without switching between multiple applications or websites. Finally, there is a need for a vehicle evaluation system that reduces stress during in-person vehicle inspection, such as while visiting a vehicle lot, by enabling fast scanning-based access to comprehensive vehicle information.

The subject matter disclosed and claimed herein, in one embodiment, comprises a vehicle information aggregation and valuation system configured to improve and accelerate vehicle buying and selling. The system includes an electronic (i.e., mobile) user device executing a mobile application and a backend server platform in communication with the mobile application through one or more networks. The mobile application provides one or more graphical user interfaces configured to enable user registration, user authentication, scanning or entering a vehicle identifier comprising a vehicle identification number (VIN) and/or barcode, and requesting vehicle information. The backend server platform includes an API gateway, an authentication module, a profile module, an orchestration module, and a valuation module. The orchestration module receives the vehicle identifier from the mobile application and initiates parallel queries to a plurality of heterogeneous external data sources to retrieve vehicle facts including year, make, model, trim, mileage, color, and additional features. The retrieved vehicle facts are normalized into and transmitted to the mobile application for display, thereby enabling rapid access to aggregated vehicle details in a unified interface.

In one embodiment, the backend server platform is further configured to retrieve a third-party vehicle history report responsive to the scanned vehicle identifier, such as a report provided by a vehicle history provider. The backend server platform can further retrieve vehicle valuation information from a valuation data source and compute an estimated vehicle value, market pricing metrics, and valuation adjustment breakdowns based on mileage, options/features, vehicle condition indicators, and geographic market effects.

In this manner, the vehicle information aggregation and valuation system of the present invention overcomes long-standing deficiencies in the art by providing a fast, user-friendly, and accurate vehicle evaluation solution that integrates vehicle attribute retrieval, valuation, and vehicle history access into a single workflow. The invention reduces consumer frustration by eliminating the need to consult multiple external websites or applications and by resolving inaccuracies and inconsistencies in third-party vehicle information. The invention further improves the buying and selling experience by enabling rapid VIN/barcode scanning during in-person inspection and by providing deal classification to assist in comparing pricing options. As a result, the invention offers enhanced convenience, improved decision-making, reduced stress, and increased efficiency for consumers and other users engaged in vehicle transactions.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle information aggregation and valuation system that comprises a mobile computing device, a mobile application executable on the mobile computing device, and a backend server platform. The mobile application is configured to provide one or more graphical user interfaces that enable user registration and user authentication, capture a vehicle identifier wherein the vehicle identifier comprises at least one of a vehicle identification number (VIN) and a barcode, and to transmit the vehicle identifier to the backend server platform.

The backend server platform comprises one or more processors and one or more memories storing instructions that, when executed by the one or more processors, cause the backend server platform to receive, via an API gateway, a request comprising the vehicle identifier from the mobile application, to authenticate a user associated with the request using an authentication module, and to retrieve user profile data and preferences using a profile module. The backend server platform is further configured to retrieve vehicle information from a plurality of external data sources using an orchestration module, wherein retrieving vehicle information comprises executing queries to heterogeneous data sources in parallel, and to normalize the retrieved vehicle information into a canonical vehicle record.

In a further embodiment, the backend server platform is further configured to compute vehicle valuation information for the vehicle using a valuation module, wherein computing vehicle valuation information comprises generating an estimated value for the vehicle and retrieving a vehicle history report responsive to the vehicle identifier from a third-party vehicle history report system. The backend server platform transmits, to the mobile application, the canonical vehicle record comprising aggregated vehicle attributes, the vehicle valuation information, and access to the vehicle history report. The mobile application displays, within a vehicle information graphical user interface, consolidated vehicle details including the aggregated vehicle attributes, the vehicle valuation information, and access to the vehicle history report.

In still another embodiment, a computer-implemented method of providing aggregated vehicle information to a user is described and is performed using a mobile application executed on a mobile computing device and a backend server platform. The method comprises launching the mobile application on the mobile computing device. The method further comprises receiving authentication credentials via the mobile application and establishing an authenticated session with the backend server platform. Further, the method includes capturing, using a camera of the mobile computing device through the mobile application, a vehicle identifier comprising a VIN or barcode, and transmitting the vehicle identifier to the backend server platform. The method further comprises retrieving, by the backend server platform, vehicle data associated with the vehicle identifier by querying one or more external data sources and normalizing the vehicle data into a canonical vehicle record. The backend server platform retrieves a vehicle history report responsive to the vehicle identifier from a third-party vehicle history provider and generating vehicle valuation information including an estimated vehicle value. The method further comprises displaying, by the mobile application, car information comprising the canonical vehicle record, the vehicle valuation information, and access to the vehicle history report within an application workflow.

In one embodiment, a vehicle information verification system is disclosed and comprises a mobile computing device having a display and a camera and configured to execute a vehicle information application, and the system further comprises a backend server platform in communication with the mobile computing device. The backend server platform is configured to receive a vehicle identifier obtained by scanning a VIN or barcode using the camera. The backend server platform is further configured to retrieve vehicle facts associated with the vehicle identifier from multiple independent sources comprising a plurality of heterogeneous external data sources. The backend server platform is further configured to compare retrieved vehicle attributes and determine one or more attribute conflicts between at least a first independent source and a second independent source.

In one aspect, the backend server platform is configured to receive a vehicle identifier obtained via scanning a VIN of a vehicle using the VIN reader interface. The backend server platform is further configured to retrieve vehicle valuation information for the vehicle including an estimated value from a valuation data source and to retrieve pricing information for the vehicle including a listing price from an inventory data source. The backend server platform is further configured to calculate a deal score based at least on a relationship between the listing price and the estimated value and to determine a deal classification based on the deal score.

In yet another embodiment, capturing the vehicle identifier comprises capturing an image of the VIN or barcode and extracting the VIN using at least one of barcode decoding and optical character recognition.

In one embodiment, the plurality of external data sources comprises a third-party vehicle history report system comprising a Carfax system and comprises a valuation system comprising a Kelly Blue Book system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram view of vehicle information aggregation and valuation system of the preset invention in accordance with the disclosed structure;

FIG. 2 illustrates a flowchart depicting steps of providing aggregated vehicle information to a user via the mobile application using the system of the present invention in accordance with the disclosed architecture;

FIG. 3 illustrates an exemplary account creation graphical user interface (GUI) of the vehicle information application in accordance with the disclosed architecture;

FIG. 4 illustrates an example map-based graphical user interface displayed by the vehicle information application in accordance with the disclosed architecture;

FIG. 5 illustrates an exemplary vehicle information graphical user interface (GUI) displayed by the vehicle information application configured to facilitate vehicle buying and selling;

FIG. 6 illustrates a vehicle report graphical user interface (GUI) displayed by the vehicle information application of the present invention in accordance with the disclosed architecture;

FIG. 7 illustrates a vehicle valuation graphical user interface (GUI) displayed by the vehicle information application to provide valuation outputs for a selected vehicle and to present valuation adjustments based on vehicle attributes, in accordance with the disclosed architecture;

FIG. 8 illustrates an exemplary vehicle identifier capture graphical user interface (GUI) of the vehicle information application configured to capture vehicle identification indicia from a physical vehicle in accordance with the disclosed architecture;

FIG. 9 illustrates an exemplary vehicle search graphical user interface (GUI) of the vehicle information application configured to enable a user to search for vehicles in accordance with the disclosed structure;

FIG. 10 illustrates a flowchart for verifying vehicle information and presenting conflicting vehicle facts in accordance with the disclosed architecture; and

FIG. 11 illustrates a flowchart depicting steps for generating a deal score for a vehicle and rendering a deal label within the vehicle information application in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vehicle information aggregation and valuation system that overcomes the limitations of conventional vehicle shopping tools and fragmented third-party information sources. There is a long-felt need for a vehicle buying and selling solution that reduces the time and effort required to research vehicles, locate appropriate inventory at dealerships or private sellers, and compare pricing options across multiple platforms. Additionally, there exists a need for a system that resolves inaccuracies and inconsistencies in third-party vehicle facts. Moreover, there is a need for a unified workflow that enables a user to rapidly obtain reliable vehicle attributes, vehicle valuation information, and vehicle history information without switching between multiple applications or websites. Finally, there is a need for a vehicle evaluation system that reduces stress during in-person vehicle inspection, such as while visiting a vehicle lot, by enabling fast scanning-based access to comprehensive vehicle information.

The present invention, in one exemplary embodiment, is a computer-implemented method of providing aggregated vehicle information to a user and is performed using a mobile application executed on a mobile computing device and a backend server platform. The method comprises launching the mobile application on the mobile computing device. The method further comprises receiving authentication credentials via the mobile application and establishing an authenticated session with the backend server platform. Further, the method includes capturing, using a camera of the mobile computing device through the mobile application, a vehicle identifier comprising a VIN or barcode, and transmitting the vehicle identifier to the backend server platform. The method further comprises retrieving, by the backend server platform, vehicle data associated with the vehicle identifier by querying one or more external data sources and normalizing the vehicle data into a canonical vehicle record. The backend server platform retrieves a vehicle history report responsive to the vehicle identifier from a third-party vehicle history provider and generating vehicle valuation information including an estimated vehicle value. The method further comprises displaying, by the mobile application, car information comprising the canonical vehicle record, the vehicle valuation information, and access to the vehicle history report within a unified application workflow.

Reference will now be made in detail to the present preferred embodiments of the invention, examples of which are illustrated in the accompanying drawings. Wherever possible, the same reference numerals are used in the drawings and the description to refer to the same or like parts.

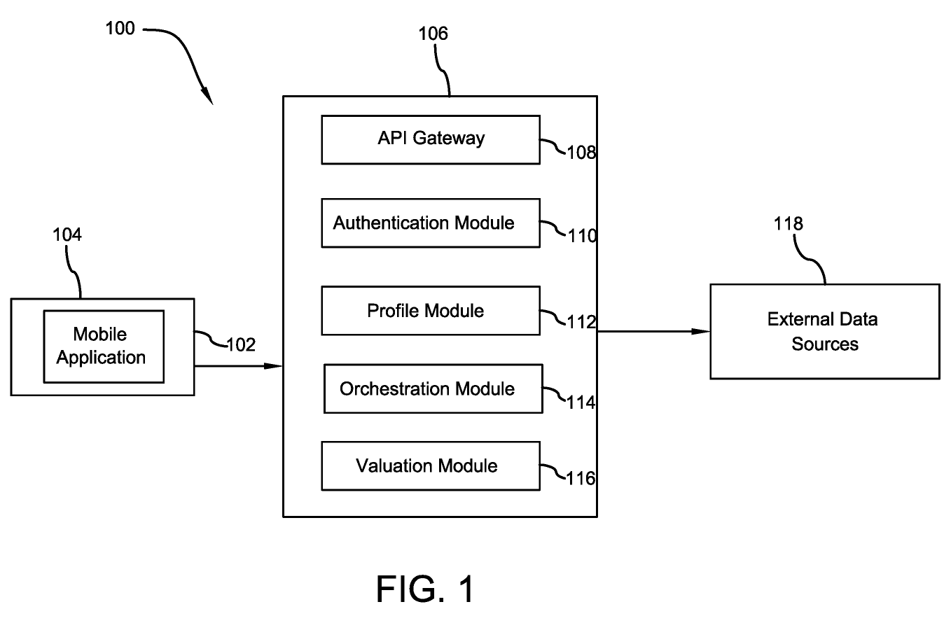

Referring initially to the drawings, FIG. 1 illustrates a block diagram view of vehicle information aggregation and valuation system of the preset invention in accordance with the disclosed structure. The vehicle information aggregation and valuation system 100 of the present invention is configured to improve and accelerate vehicle buying and selling. More specifically, the vehicle valuation system 100 includes an electronic (i.e., mobile) user device 104 executing a mobile application 102. The mobile application 102 can comprise a software program executed on a smartphone, tablet, or other mobile computing device and can provide one or more graphical user interfaces enabling a user to perform actions including, but not limited to, user registration, user authentication, scanning or entering vehicle identifiers (i.e., VIN/barcode), requesting vehicle information, viewing vehicle valuation information, and accessing third-party vehicle history and/or specification information.

The electronic device 104 communicates, via one or more networks (i.e., the Internet, cellular networks, Wi-Fi, or other communication links), with a backend server platform (i.e., server) 106. The backend server platform (i.e., server) 106 can be implemented using one or more physical servers, virtual machines, containerized services, cloud infrastructure services, or distributed computing resources. In some embodiments, the backend platform 106 comprises a plurality of modules for receiving requests from the mobile application 102, performing authentication, coordinating retrieval of vehicle-related information from external sources, generating normalized vehicle records, and returning results to the mobile application 102.

In the illustrated embodiment, the backend server platform (i.e., server) 106 includes an API gateway 108 configured to receive inbound communications from the mobile application 102, such as application programming interface (API) calls, and to route the calls to the internal backend modules. The API gateway 108 can perform request parsing, authentication token handling, and response formatting. The API gateway 108 may also provide a backend-for-frontend (BFF) layer that formats responses to optimize rendering in the mobile application 102.

An authentication module 110 is configured to manage user identity and access control for the vehicle valuation system 100. The authentication module 110 can perform user account creation, login credential verification, password reset, and session validation. In some embodiments, the authentication module 110 provides authentication policies including multi-factor authentication, device-based authentication, and anomalous login detection. Whenever a user logins to the vehicle valuation system 100, the authentication module 110 validates the credentials enabling only authenticated users to use the vehicle valuation system 100.

A profile module 112 is configured to maintain user profile data and preferences associated with a user account. User profile data can include, by way of example, location, preferred search settings, stored vehicles, interaction history, and notification preferences. The profile module 112 can provide personalization signals used by other modules (i.e., orchestration module 114 and valuation module 116), for example to adjust search results by geographic proximity or to tailor valuation assumptions and display settings.

The orchestration module 114 is configured to coordinate vehicle information retrieval and aggregation. In the preferred embodiment, the orchestration module 114 receives a vehicle identifier (i.e., VIN or barcode-derived identifier) from the mobile application 102 via the API Gateway 108 and is configured to initiate a set of queries to retrieve vehicle data or information from one or more information providers as described later in the disclosure. The orchestration module 114 can execute parallel calls to heterogeneous data sources, normalize retrieved data into a canonical structure, may detect inconsistencies across sources, and produce an aggregated vehicle information response for delivery to the mobile application 102. The orchestration module 114 can further trigger retrieval of vehicle history reports, vehicle specifications, options/features, and other vehicle facts.

The valuation module 116 is configured to generate, retrieve, or compute vehicle valuation information for vehicles, including estimated values, market pricing metrics, and pricing adjustment breakdowns. In some embodiments, the valuation module 116 may query one or more valuation providers and may compute deal scoring or comparative valuation analysis using information from the orchestration module 114. Valuation data may be incorporated into the aggregated vehicle record provided to the mobile application 102. In some embodiments, the valuation module 116 supports display of value adjustments based on mileage, options/features, vehicle condition indicators, geographic market effects, and/or third-party history report indicators.

The vehicle valuation system 100 further can include or is coupled to one or more external data sources 118. The external data sources 118 can comprise third-party services and databases that store or provide vehicle-related data, including, but not limited to third-party vehicle history report systems, valuation systems, vehicle specification databases, dealer and inventory databases, and/or listing/marketplace systems.

In the preferred embodiment, the backend platform 106 communicates with the external data sources 118, such as via API calls or other data exchange mechanisms. For example, the orchestration module 114 and the valuation module 116 can transmit vehicle identifiers and receive corresponding vehicle data or reports. The retrieved data or information from external data sources 118 may be transformed, normalized, and aggregated into a unified vehicle information dataset, and returned to the mobile application 102 for display.

In some embodiments, the modules of backend platform 106 can be implemented as microservices, containerized services, or distributed components. The boundaries shown in FIG. 1 are illustrative, and functions described herein may be combined, subdivided, replicated, or distributed among multiple computing devices. Similarly, communications may occur via secure protocols, can include encryption, and may be mediated by additional components such as load balancers, caching layers, and monitoring subsystems.

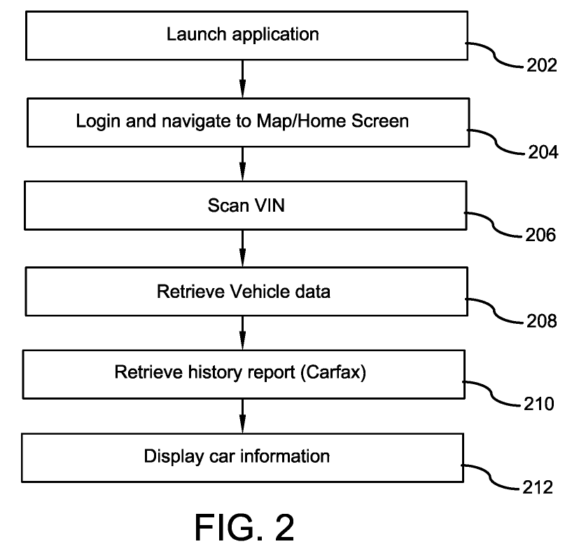

FIG. 2 illustrates a flowchart depicting steps of providing aggregated vehicle information to a user via the mobile application using the system of the present invention in accordance with the disclosed architecture. As shown in FIG. 2, initially a user launches the vehicle information application 102 (also referred to as the ‘Savvywheels’ mobile application) on the mobile computing device 104 (Step 202).

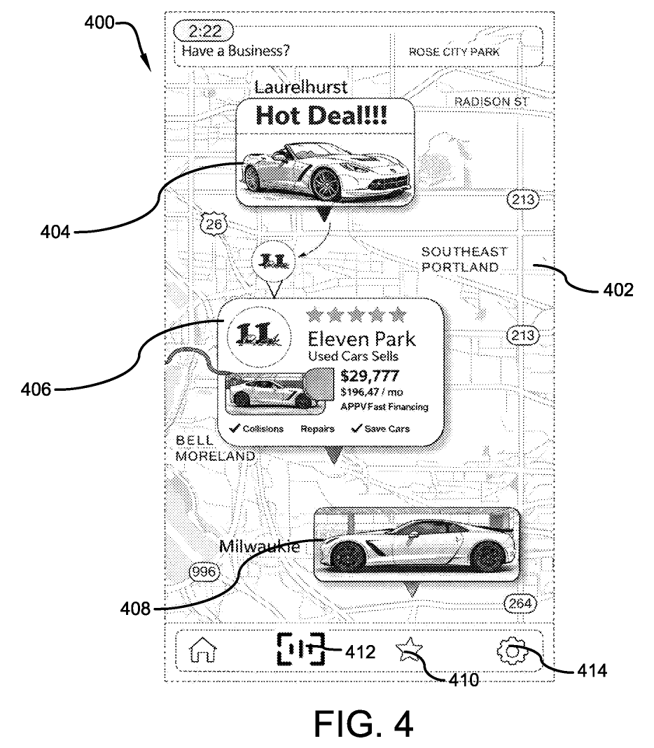

Then, the user performs authentication and navigation actions, including logging into the application and navigating to a primary interface screen (Step 204). In the illustrated embodiment, the primary interface screen is a Map/Home screen (FIG. 4) configured to provide access to core features of the application. Logging in can comprise transmitting user credentials to a backend platform, validating the credentials, and establishing a user session associated with a user account.

Thereafter, a vehicle identification number (VIN) is scanned (Step 206). Scanning the VIN may be performed using a camera and a VIN/barcode reader interface of the mobile application. In some embodiments, scanning comprises capturing an image of the VIN or barcode, extracting the VIN using computer vision or decoding techniques, and validating the VIN format.

At step 208, vehicle data associated with the scanned VIN is retrieved. Retrieving vehicle data can include transmitting the scanned VIN (or a derived vehicle identifier token) from the mobile device 104 to the backend platform 106. The backend platform 106 may query one or more vehicle data sources to obtain vehicle attributes such as year, make, model, trim, mileage, color, features/options, and pricing or vehicle valuation information (i.e., estimated value). The retrieved vehicle data may be normalized into a canonical vehicle record for display.

A vehicle history report responsive to the scanned VIN is then retrieved (Step 210). Retrieving the vehicle history report includes retrieving a report from a third-party history report provider (i.e., Carfax). The backend platform may request the report using the VIN, receive report data and/or an access link, and prepare the report for presentation through the application interface.

Finally, car information within the mobile application is displayed (Step 212). The displayed car information can comprise aggregated vehicle attributes, vehicle valuation information, and access to the vehicle history report. The car information enables a user to view consolidated vehicle details and access valuation and history report details without leaving the application 102.

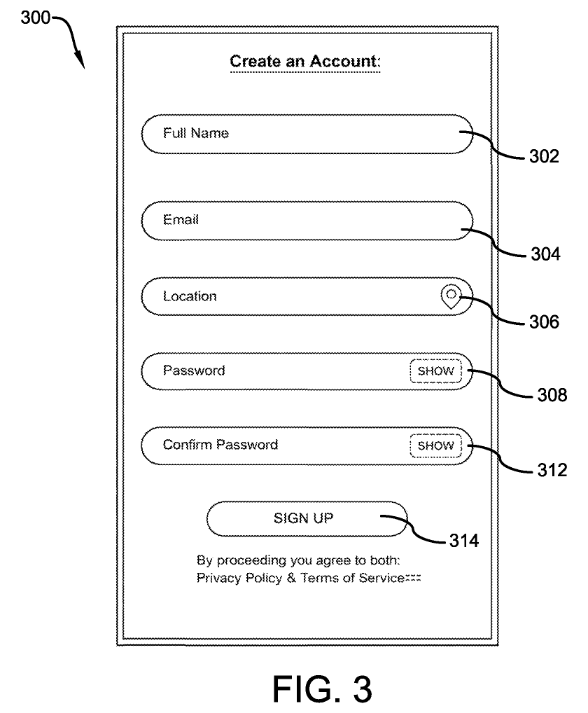

FIG. 3 illustrates an exemplary account creation graphical user interface (GUI) of the vehicle information application in accordance with the disclosed architecture. The account creation GUI 300 may be presented on a display of the user computing device of FIG. 1 to enable a user to create a user account for accessing one or more services of the vehicle information application and an associated backend platform.

As shown in FIG. 3, the account creation GUI 300 comprises a plurality of user interface controls configured to receive account registration information. In the present embodiment, the plurality of controls includes a full name input field 302 configured to receive a name associated with the user, and an email input field 304 configured to receive an email address or other user identifier. The plurality of controls further includes a location input field 306 configured to receive a geographic location associated with the user.

In some embodiments, the location input field 306 may be manually populated and/or populated using location information obtained from one or more location services of the user computing device. As illustrated, the location input field 306 may be associated with a location selection control (i.e., an icon) to facilitate entry or selection of location information.

The account creation GUI 300 further includes a password input field 308 configured to receive a password. In some embodiments, the password input field 308 is associated with a password display control configured to selectively present password characters in a visible form and/or in a masked form. The account creation GUI 300 further includes a confirm password input field 312 configured to receive a second password entry corresponding to the password received in the password input field 308. In some embodiments, the confirm password input field 312 is also associated with a password display control configured to selectively reveal and/or mask password characters.

The account creation GUI 300 further includes a registration control 314 (i.e., a “SIGN UP” control) configured to, upon user selection, initiate account registration. In response to selection of the registration control 314, the vehicle information application can transmit a registration request to a backend platform. The registration request can include at least the user-provided account registration information entered into one or more of the input fields 302–312. The backend platform may validate the registration request, create the user account, and generate authentication credentials (i.e., a session token, access token, and/or refresh token). The backend platform can transmit the authentication credentials to the vehicle information application, thereby enabling an authenticated user session.

In certain embodiments, the account creation GUI 300 further includes a disclosure region indicating that account registration is subject to one or more policies and/or terms of service (i.e., a privacy policy and terms of service). The disclosure region may be displayed adjacent to, or proximate to, the registration control 314.

FIG. 4 illustrates an example map-based graphical user interface displayed by the vehicle information application in accordance with the disclosed architecture. The map-based GUI 400 enables a user to browse vehicles based on geographic location, identify vehicle listings of interest, and navigate to additional vehicle information resources including vehicle detail pages, vehicle valuation information, and vehicle history reports.

As shown in FIG. 4, the map-based GUI 400 includes a map region 402 displaying a geographic map (i.e., a street map) corresponding to a selected location or an area proximal to the current location of user logged in the vehicle valuation system 100. In some embodiments, the map region 402 may be generated using a mapping service and can include map features such as streets, neighborhoods, points of interest, and location labels.

The map-based GUI 400 further includes one or more vehicle listing indicators 404, 406, and 408 positioned within the map region 402 at geographic coordinates corresponding to associated vehicle listings. Each vehicle listing indicator 404–408 may represent a vehicle that is available for purchase and/or sale. In the preferred embodiment, each vehicle listing indicator 404–408 is selectable, and selection of a given indicator causes the vehicle information application to navigate to a vehicle information interface corresponding to the selected vehicle (i.e., a car information page including aggregated vehicle attributes, vehicle valuation information, and access to a vehicle history report).

The map-based GUI 400 can further include an interactive action region associated with vehicle listing indicator 406. For example, the vehicle listing indicator 406 can include one or more selectable controls enabling actions such as viewing vehicle collections, viewing repair information, viewing saved vehicles, initiating a scan-based lookup, and/or otherwise accessing related vehicle information.

The map-based GUI 400 further includes a navigation region providing access to primary application functions. In the illustrated embodiment, the navigation region includes a plurality of selectable navigation controls, such as a favorites control 410, a scan/VIN reader control 412, and a settings control 414. The favorites control 410 can cause navigation to a favorites interface presenting saved vehicles associated with the user account.

The scan/VIN reader control 412 can initiate a VIN or barcode scanning interface for identifying a vehicle and for retrieving associated vehicle information. The settings control 414 can cause navigation to a settings interface enabling management of user preferences, notifications, account settings, and privacy settings. Additional navigation controls may be provided (i.e., a home control or other interface controls), as depicted.

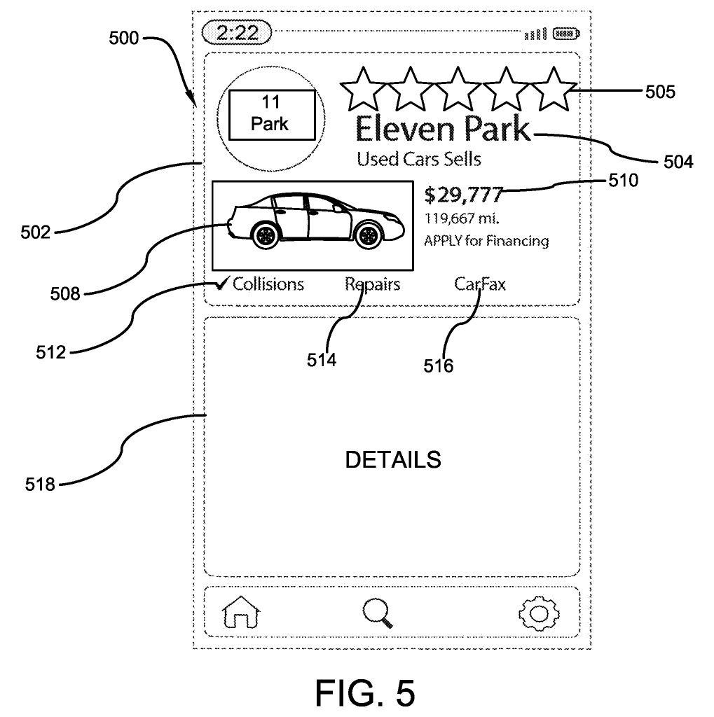

FIG. 5 illustrates an exemplary vehicle information graphical user interface (GUI) displayed by the vehicle information application configured to facilitate vehicle buying and selling. The vehicle information GUI 500 may be displayed on the user computing device responsive to selection of a vehicle listing from a map-based interface, search results interface, favorites interface, and/or a VIN scan workflow.

As shown in FIG. 5, the vehicle information GUI 500 includes an upper vehicle summary region 502 configured to present vehicle listing information for a selected vehicle. In the illustrated embodiment, the vehicle summary region 502 includes a dealer identifier and/or branding element 504 (i.e., a dealer name and/or logo) and can further include one or more rating indicators 505 (i.e., star icons) corresponding to a rating or reputation measure for the dealer and/or listing.

The vehicle summary region 502 further includes a vehicle image element 508 configured to display an image of the selected vehicle. In some embodiments, the vehicle image element 508 may correspond to a vehicle photo obtained from an inventory listing source, marketplace listing source, or captured user image.

The vehicle information GUI 500 further includes a pricing element 510 configured to present pricing-related information, such as an asking price for the selected vehicle (i.e., “$29,777”) and/or other associated pricing or financing information. In certain embodiments, the pricing element 510 may additionally include mileage and/or usage information (i.e., odometer value) and can include one or more selectable controls for initiating an action such as applying for financing (i.e., an “APPLY for Financing” control).

The vehicle information GUI 500 further comprises a plurality of action controls enabling access to related vehicle information and services. For example, in the illustrated embodiment, the vehicle summary region 502 includes a collisions control 512, a repairs control 514, and a vehicle history report control 516 (i.e., a “CarFax” control). The collisions control 512 may be selectable to display collision-related information associated with the vehicle and/or report derived vehicle history indicators.

The repairs control 514 may be selectable to display repair-related information associated with the vehicle. The vehicle history report control 516 may be selectable to initiate retrieval and presentation of a vehicle history report from a third-party vehicle history report provider (i.e., Carfax), thereby enabling the user to access the vehicle history report within the application interface.

In addition, the vehicle information GUI 500 includes a vehicle detail region 518 configured to present expanded vehicle detail content associated with the selected vehicle. The expanded vehicle detail content can include vehicle attributes, options/features, trim details, descriptions, aggregated third-party vehicle facts, valuation outputs, and/or other informational elements. In some embodiments, the vehicle detail region 518 is populated responsive to retrieval and aggregation of vehicle data or information from external data sources.

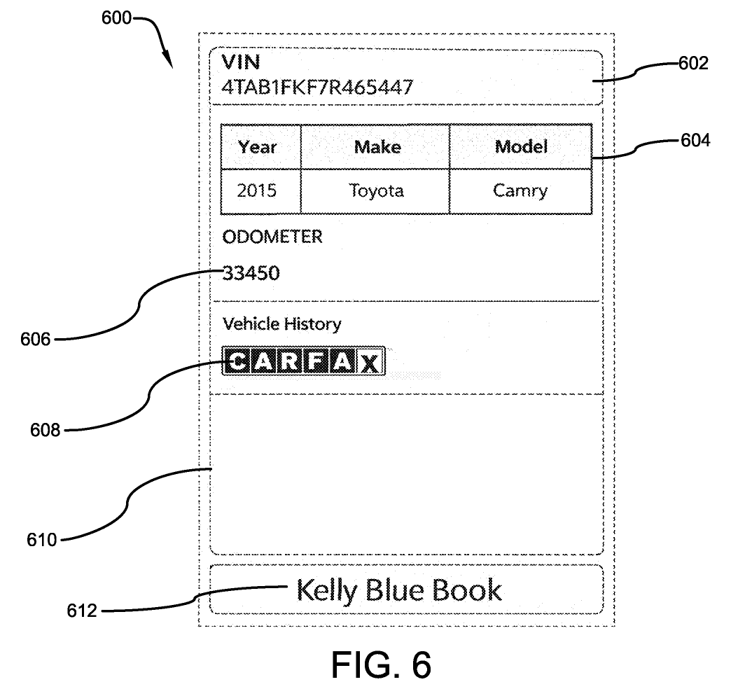

FIG. 6 illustrates a vehicle report graphical user interface (GUI) displayed by the vehicle information application of the present invention in accordance with the disclosed architecture. The vehicle report GUI 600 includes a vehicle identification region 602 configured to present a vehicle identifier associated with the selected vehicle. In the illustrated embodiment, the vehicle identifier comprises a vehicle identification number (VIN) (i.e., “4TAB1FKF7R465447”), though in other embodiments the vehicle identifier may additionally or alternatively comprise a barcode, a derived vehicle identifier token, or other unique vehicle identifier.

The vehicle report GUI 600 further includes a vehicle attribute summary region 604 configured to present one or more vehicle attributes associated with the selected vehicle. In the illustrated embodiment, the vehicle attribute summary region 604 includes a tabular layout presenting at least a vehicle year, a vehicle make, and a vehicle model (i.e., “2015,” “Toyota,” “Camry”). In other embodiments, additional attributes may be displayed, including trim, body style, drivetrain, engine type, color, and other features.

An odometer region 606 is configured to display mileage information for the selected vehicle (i.e., an odometer value “33450”). In some embodiments, the odometer region 606 can include mileage retrieved from one or more external data sources and/or derived from vehicle history data.

A vehicle history report region 608 is configured to provide access to vehicle history information. In some embodiments, the vehicle history report region 608 provides integrated access to a third-party vehicle history report provider (i.e., Carfax). For example, the vehicle history report region 608 may display a history report identifier, a selectable history report control, and/or content derived from a vehicle history report.

The vehicle report GUI 600 further includes a details region 610 configured to present additional vehicle information, including expanded vehicle history content, aggregated third-party vehicle facts, vehicle condition indicators, title information, accident indicators, service records, and/or other report details.

A valuation access control 612, which in the illustrated embodiment comprises a control labeled “Kelly Blue Book” is selectable to initiate retrieval and presentation of vehicle valuation information for the selected vehicle from a valuation data source (i.e., a Kelly Blue Book system). In one embodiment, selection of the valuation access control 612 causes the vehicle information application to display a valuation interface including estimated vehicle value, pricing breakdowns, and/or adjustments based on vehicle attributes and usage.

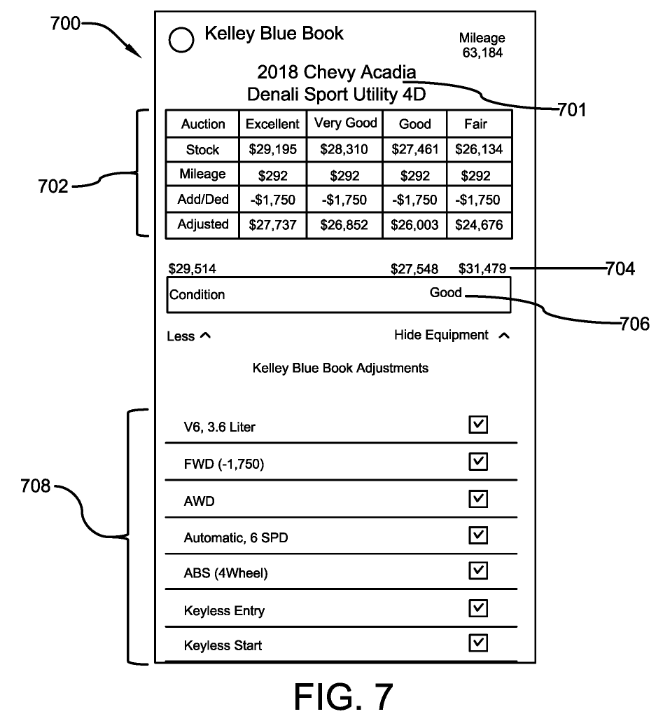

FIG. 7 illustrates a vehicle valuation graphical user interface (GUI) displayed by the vehicle information application to provide valuation outputs for a selected vehicle and to present valuation adjustments based on vehicle attributes, in accordance with the disclosed architecture. As shown in FIG. 7, the vehicle valuation GUI 700 includes a valuation header region 701 configured to identify a valuation provider and vehicle context. In the illustrated embodiment, the header region identifies a valuation system (i.e., “Kelly Blue Book”) and includes vehicle descriptive information such as year, make, model, and trim, and can further include a mileage indicator.

The vehicle valuation GUI 700 further includes a valuation summary region 702 configured to present valuation outputs for the selected vehicle. In the illustrated embodiment, the valuation summary region 702 comprises a tabular presentation of valuation amounts across a plurality of vehicle conditions and/or categories (i.e., auction value, excellent, very good, good, fair). The valuation summary region 702 can include base value metrics and computed adjustments for the selected vehicle.

A valuation result region 704 is configured to present one or more consolidated valuation results for the selected vehicle (i.e., a final estimated value and/or a pricing range). In some embodiments, the valuation result region 704 presents a low-end and high-end valuation range and/or a single computed price point.

The vehicle valuation GUI 700 further includes a condition indicator 706 configured to represent a condition category associated with the selected vehicle (i.e., “good”) and/or a selection of a valuation band. In certain embodiments, the condition indicator 706 is used to determine which valuation outputs are presented as primary values.

The vehicle valuation GUI 700 includes an adjustment region 708 configured to provide a plurality of selectable valuation adjustment items corresponding to vehicle equipment, options, configuration, and/or other value-affecting attributes. In the present embodiment, the adjustment region 708 includes a list of equipment and configuration items such as drivetrain type, transmission type, braking features, and convenience features. Each adjustment item may be associated with a selectable control (i.e., checkboxes) that enables inclusion or exclusion of the corresponding item from the valuation computation. In some embodiments, adjustment selections modify valuation outputs presented in valuation summary region 702 and valuation result region 704.

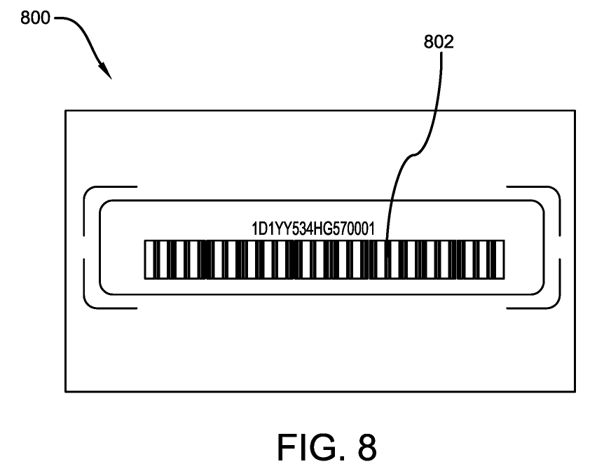

FIG. 8 illustrates an exemplary vehicle identifier capture graphical user interface (GUI) of the vehicle information application configured to capture vehicle identification indicia from a physical vehicle in accordance with the disclosed architecture. As shown in FIG. 8, the vehicle identifier capture GUI 800 presents a camera capture region configured to display a live image obtained from a camera sensor of the user computing device 104 in which the application 102 is installed and executed. The camera capture region includes a visual targeting overlay configured to assist the user in positioning a VIN label or barcode within a scanning region.

The vehicle identifier capture GUI 800 further includes a vehicle identifier indicia region 802 corresponding to the VIN/barcode to be scanned. In some embodiments, the vehicle identifier indicia region 802 includes a barcode and human-readable VIN characters printed on a vehicle component. The vehicle information application may be configured to automatically detect the VIN/barcode within the displayed camera image and to decode the VIN/barcode to generate a vehicle identifier token.

The vehicle information application 102 can perform one or more computer vision operations to support scanning, barcode detection, optical character recognition (OCR), and/or VIN decoding. Upon successful capture and decoding of the VIN/barcode, the application 102 can transmit the decoded VIN (or derived vehicle identifier token) to the backend platform 106 for retrieval of vehicle information, valuation data, and/or a vehicle history report as described herein.

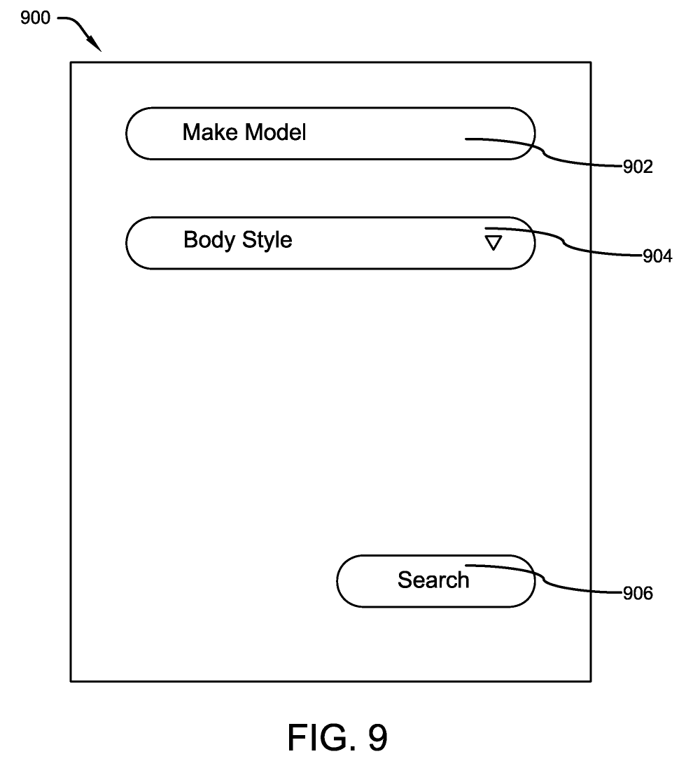

FIG. 9 illustrates an exemplary vehicle search graphical user interface (GUI) of the vehicle information application configured to enable a user to search for vehicles in accordance with the disclosed structure. The vehicle search GUI 900 includes one or more search parameter controls configured to receive search criteria for retrieving vehicle listings from an inventory dataset and external listing sources. In the present embodiment, the vehicle search GUI 900 includes a make/model input control 902 configured to receive a vehicle make and/or model selection. The make/model input control 902 can comprise a text entry control, a selectable list control, an auto-complete control, or a menu-based control.

A body style selection control 904 is configured to receive a selection of a vehicle body style. The body style selection control 904 can include a drop-down selection element, though other selection mechanisms may be used. In certain embodiments, selection of the body style selection control 904 causes presentation of a list of available body styles for selection. The vehicle search GUI 900 further includes a search execution control 906 (i.e., a “SEARCH” control) configured to, upon selection, initiate a vehicle search query. In response to selection of the search execution control 906, the vehicle information application may generate a search request including the selected/entered search parameters from controls 902 and 904 and transmit the search request to a backend platform. The backend platform can execute the search request against one or more datasets (i.e., an inventory dataset, listings dataset, search index, and/or external sources) and return matching vehicle results for presentation in a search results interface (i.e., a grid or list of vehicle tiles).

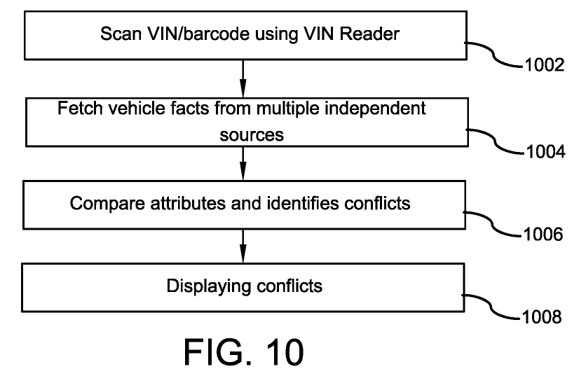

FIG. 10 illustrates a flowchart for verifying vehicle information and presenting conflicting vehicle facts in accordance with the disclosed architecture. Initially, a vehicle identifier is scanned using a VIN reader interface (Step 1002). Scanning can include scanning a VIN and/or barcode corresponding to a physical vehicle using a camera-based scanning interface of the vehicle information application. Scanning can include decoding a barcode and/or applying optical character recognition to obtain a VIN string and generating a vehicle identifier token corresponding to the vehicle.

Then, vehicle facts are retrieved from a plurality of independent sources (Step 1004). In some embodiments, the backend platform receives the vehicle identifier token and queries a plurality of heterogeneous third party data sources for vehicle information. The fetched vehicle facts can include, by way of example, year, make, model, trim, mileage, color, vehicle options/features, estimated value, listing price information, and/or vehicle history report information.

Thereafter, retrieved vehicle attributes are compared, and conflicts are identified (Step 1006). Comparing attributes comprises normalizing vehicle facts into a canonical vehicle record and determining whether one or more attributes differ beyond a threshold between sources. Conflicts can include, for example, inconsistencies in trim level, odometer value, vehicle condition, title status, vehicle configuration, or other third-party vehicle facts.

Finally, the conflicts are displayed for review of the user (Step 1008). In some embodiments, the vehicle information application presents a conflict indicator identifying attributes that are inconsistent across sources.

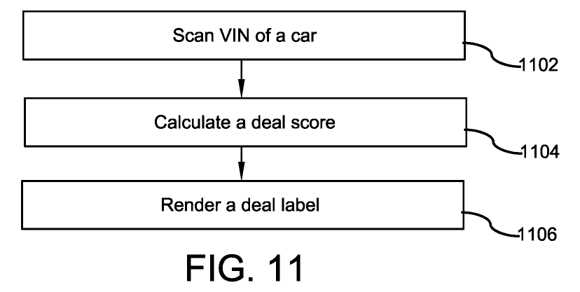

FIG. 11 illustrates a flowchart depicting steps for generating a deal score for a vehicle and rendering a deal label within the vehicle information application in accordance with the disclosed architecture. Initially, a vehicle identification number (VIN) of a car is scanned (Step 1102).

Then, a deal score associated with the identified vehicle is automatically calculated (Step 1104). In some embodiments, calculating the deal score comprises retrieving one or more pricing and valuation metrics associated with the vehicle and computing a numerical score representing attractiveness of the deal. For example, the backend platform may retrieve an estimated vehicle value from a valuation data source and retrieve a listing price from an inventory source. The deal score may be computed based on a relationship between the listing price and the estimated vehicle value.

Thereafter, a deal label within the vehicle information application is rendered (Step 1106). In some embodiments, the deal label comprises a textual and/or graphical indicator categorizing the vehicle as a particular type of deal (i.e., “Hot Deal,” “Good Deal,” “Fair Price,” “Overpriced,” or similar) as shown in FIG. 4. The deal label may be rendered in association with a map-based interface, a vehicle information interface, and/or search results interface.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mobile-based vehicle information aggregation and valuation system”, “vehicle information aggregation and valuation system”, “vehicular information system”, and “system” are interchangeable and refer to the vehicle information aggregation and valuation system 100 of the present invention.

Notwithstanding the forgoing, the vehicle information aggregation and valuation system 100 of the present invention can be of any suitable configuration as is known in the art without affecting the overall concept of the invention, provided that it accomplishes the above stated objectives. One of ordinary skill in the art will appreciate that the vehicle information aggregation and valuation system 100 shown in the FIGS. are for illustrative purposes only, and that many other configurations of the vehicle information aggregation and valuation system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle information aggregation and valuation system comprising:
an electronic user device;
a mobile application;
a network;
an API gateway;
an authentication module;
an orchestration module;
a valuation module;
an external data source; and
a VIN reader control;
wherein said mobile application comprises a software program executable on said electronic user device;
wherein said electronic user device comprises a graphical user interface for performing one or more selected from the group consisting of a user registration, a user authentication, an entering of vehicle identifiers, requesting vehicle information, viewing vehicle valuation information, accessing third-party vehicle history, and accessing vehicle specification information;
wherein said electronic user device communicates with a server through said network;
wherein said server comprises said API gateway;
wherein said API gateway is configured to receive inbound communications from said mobile application;
wherein said authentication module is configured to manage user identity and access control for the vehicle valuation system;
wherein said authentication module performs one or more selected from the group consisting of user account creation, login credential verification, password reset, and session validation;
wherein said orchestration module is configured to retrieve said vehicle valuation information;
wherein said orchestration module receives a vehicle identifier from said mobile application via said API gateway;
wherein said orchestration module is configured to initiate a set of queries to retrieve said vehicle valuation information from one or more said external data source;
wherein said VIN reader control initiates a VIN interface to read a vehicle VIN for identifying a vehicle and for retrieving associated said vehicle valuation information;
wherein said vehicle valuation information selected from the group consisting of vehicle history reports, vehicle specifications, vehicle options, and vehicle features; and
further wherein said valuation module is configured to generate said vehicle valuation information for vehicles using valuation data selected from the group consisting of estimated values, market pricing metrics, pricing adjustment breakdowns, vehicle mileage, vehicle options, vehicle features, vehicle condition indicators, geographic market effects, and vehicle history reports.

2. The vehicle information aggregation and valuation system of claim 1, wherein said VIN reader control is configured to capture vehicle identification indicia from a physical vehicle and comprises a camera capture region to display a live image obtained from a camera sensor of said electronic user device.

3. The vehicle information aggregation and valuation system of claim 2 further comprising a profile module, wherein said profile module is configured to maintain user profile data and preferences associated with a user account.

4. The vehicle information aggregation and valuation system of claim 3, wherein said user profile data comprises one or more selected from the group consisting of user location, preferred search settings, stored vehicles, interaction history, and notification preferences.

5. The vehicle information aggregation and valuation system of claim 4, wherein said external data source connected to the vehicle information system.

6. The vehicle information aggregation and valuation system of claim 5, wherein said external data source comprises third-party databases that provide vehicle-related data selected from the group consisting of third-party vehicle history report systems, valuation systems, vehicle specification databases, dealer databases, inventory databases, and marketplace listing systems.

7. A vehicle information aggregation and valuation system comprising:
an electronic user device;
a mobile application;
a network;
an API gateway;
an authentication module;
an orchestration module;
a valuation module;
an external data source; and
a deal score;
wherein said mobile application comprises a software program executable on said electronic user device;
wherein said electronic user device comprises a graphical user interface for performing one or more selected from the group consisting of a user registration, a user authentication, an entering of vehicle identifiers, requesting vehicle information, viewing vehicle valuation information, accessing third-party vehicle history, and accessing vehicle specification information;
wherein said electronic user device communicates with a server through said network;
wherein said server comprises said API gateway;
wherein said API gateway is configured to receive inbound communications from said mobile application;
wherein said authentication module is configured to manage user identity and access control for the vehicle valuation system;
wherein said authentication module performs one or more selected from the group consisting of user account creation, login credential verification, password reset, and session validation;
wherein said orchestration module is configured to retrieve said vehicle valuation information;
wherein said orchestration module receives a vehicle identifier from said mobile application via said API gateway;
wherein said orchestration module is configured to initiate a set of queries to retrieve said vehicle valuation information from one or more said external data source;
wherein said valuation module is configured to generate said vehicle valuation information for vehicles using valuation data selected from the group consisting of estimated values, market pricing metrics, pricing adjustment breakdowns, vehicle mileage, vehicle options, vehicle features, vehicle condition indicators, geographic market effects, vehicle history reports, and vehicle repair reports; and
further wherein said deal score comprises retrieving said vehicle valuation information associated with a vehicle and computing a numerical score representing a comparison of an estimated value of the vehicle and a listing price of the vehicle.

8. The vehicle information aggregation and valuation system of claim 7 further comprising a VIN reader control, wherein said VIN reader control initiates a VIN interface to read a vehicle VIN for identifying a vehicle and for retrieving associated said vehicle valuation information.

9. The vehicle information aggregation and valuation system of claim 8, wherein said vehicle valuation information selected from the group consisting of said vehicle history reports, said vehicle repair reports, vehicle specifications, vehicle options, and vehicle features.

10. The vehicle information aggregation and valuation system of claim 9, wherein said VIN reader control is configured to capture vehicle identification indicia from a physical vehicle and comprises a camera capture region to display a live image obtained from a camera sensor of said electronic user device.

11. The vehicle information aggregation and valuation system of claim 10 further comprising a profile module, wherein said profile module is configured to maintain user profile data and preferences associated with a user account.

12. The vehicle information aggregation and valuation system of claim 11, wherein said user profile data comprises one or more selected from the group consisting of user location, preferred search settings, stored vehicles, interaction history, and notification preferences.

13. The vehicle information aggregation and valuation system of claim 12, wherein said external data source connected to the vehicle information system.

14. The vehicle information aggregation and valuation system of claim 13, wherein said external data source comprises third-party databases that provide vehicle-related data selected from the group consisting of third-party vehicle history report systems, valuation systems, vehicle specification databases, dealer databases, inventory databases, and marketplace listing systems.

15. A method of valuing a vehicle, the method comprising the steps of:
providing an electronic user device, a mobile application, a network, an API gateway, an authentication module, an orchestration module, a valuation module, an external data source; and a VIN reader control, wherein said mobile application comprises a software program executable on said electronic user device;
wherein said electronic user device comprises a graphical user interface for performing one or more selected from the group consisting of a user registration, a user authentication, an entering of vehicle identifiers, requesting vehicle information, viewing vehicle valuation information, accessing third-party vehicle history, and accessing vehicle specification information;
connecting said electronic user device with a server through said network, wherein said server comprises said API gateway;
receiving inbound communications from said mobile application;
managing user identity and access control for the vehicle valuation system through said authentication module, wherein said authentication module performs one or more selected from the group consisting of user account creation, login credential verification, password reset, and session validation;
retrieving said vehicle valuation information from said orchestration module, wherein said orchestration module receives a vehicle identifier from said mobile application via said API gateway;
initiating a set of queries to retrieve said vehicle valuation information from one or more said external data source;
initiating a VIN interface with said VIN reader control to read a vehicle VIN for identifying a vehicle and for retrieving associated said vehicle valuation information, wherein said vehicle valuation information selected from the group consisting of vehicle history reports, vehicle repair reports, vehicle specifications, vehicle options, and vehicle features; and
generating said vehicle valuation information for vehicles using valuation data selected from the group consisting of estimated values, market pricing metrics, pricing adjustment breakdowns, vehicle mileage, vehicle options, vehicle features, vehicle condition indicators, geographic market effects, said vehicle history reports, and said vehicle repair reports.

16. The method of valuing a vehicle of claim 15, wherein said VIN reader control is configured to capture vehicle identification indicia from a physical vehicle and comprises a camera capture region to display a live image obtained from a camera sensor of said electronic user device.

17. The method of valuing a vehicle of claim 16 further comprising a step of providing a profile module, wherein said profile module is configured to maintain user profile data and preferences associated with a user account.

18. The method of valuing a vehicle of claim 17, wherein said user profile data comprises one or more selected from the group consisting of user location, preferred search settings, stored vehicles, interaction history, and notification preferences.

19. The method of valuing a vehicle of claim 18, wherein said external data source connected to the vehicle information system.

20. The method of valuing a vehicle of claim 19, wherein said external data source comprises third-party databases that provide vehicle-related data selected from the group consisting of third-party vehicle history report systems, valuation systems, vehicle specification databases, dealer databases, inventory databases, and marketplace listing systems.
